(19) United States
(12) Patent Application Publication
(10) Pub. No.: US 2005/0037779 A1
(43) Pub. Date: Feb. 17, 2005

(54) Method and interface for facilitating communication of location specific contents between a wireless device and other devices or systems via an interface

(75) Inventors: David Yin-Shur Ma, San Jose, CA (US); Jing Lu, Santa Clara, CA (US)

Correspondence Address: STEVENS LAW GROUP, P.O. BOX 1667, SAN JOSE, CA, 95109, US

(73) Assignee: Clarinet Systems, Inc., Fremont, CA (US)

(21) Appl. No.: 10/922,534

(22) Filed: Aug. 19, 2004

Related U.S. Application Data
(63) Continuation-in-part of application No. 09/733,312, filed on Dec. 8, 2000.
(63) Continuation-in-part of application No. 09/772,451, filed on Jan. 29, 2001.

(51) Int. Cl. H04B 7/15

(52) U.S. Cl. 455/456.6

(57) ABSTRACT

A system is provided for use in a communication interface for communication between a wireless device and the communication interface to gather local and proximal information. The communication interface is configured to communicate with other devices communicating with a network and configured to facilitate data communication between the wireless device and other devices connected to the network to retrieve and otherwise consume information pertinent to a particular location. A wireless device may then receive a packet having an embedded information address and command from a wireless device that is enabled with a protocol to establish a communication link with an application server, establish a communication link with the application server, retrieve localized information from the application server according to the received embedded command and forward the location related data to the wireless device.

### RELATED APPLICATIONS

This is a continuation in part of co-pending and commonly assigned U.S. patent application Ser. No. 09/733,312, entitled Method and Apparatus for Facilitating Communication between a Personal Data Assistant and a Computer, filed Dec. 8, 2000; and a continuation in part of co-pending and commonly assigned U.S. patent application Ser. No. 09/772,451, entitled Method and Apparatus for Facilitating Communication Between a Wireless Device and Disparate Devices or Systems, filed Jan. 29, 2001.

### BACKGROUND

The invention relates generally to communication between a wireless device, such as a personal data assistant (PDA) or cell phone and a wireless access point or computer, more particularly, to a method and interface for the wireless device to receive location specific contents from the access point without identifying the location.

A wireless device such as a PDA or cell phone is generally a portable device configured to store data and perform basic functions for a user to view, receive, transmit, store and consume data. Different types of PDAs are well known in the consumer electronics industry and are currently in widespread use. One popular device is the Palm Pilot™, made by Palm™. This device runs on a specialized operating system, known as PalmOS™. Other PDAs may be configured under different operating systems, such as the WindowsCE™ and the PocketPC™ that run under operating systems that are developed and sold by Microsoft Corporation™. Modern cellular telephones may be configured as PDAs, providing any and all of the conventional functions of PDAs. These PDAs may offer internal software applications such as an address book for keeping names and addresses, a calendar for keeping schedules and important dates, a notebook for keeping notes, an Internet application for accessing the Internet to send and receive E-mail and other services, specialized applications for communicating with computer servers over a network and other applications.

Most conventional PDAs include the ability to communicate with a computer system via a network, such as an Ethernet. One method of performing such communication is to dial up a connection with a computer server that is connected to network via an infrared access point connected to a local area network (LAN). Such a connection is known as a LAN access point, or LAP. The protocol used to communicate with the server is known as the TCP/IP/PPP protocol. This is a protocol commonly used in the industry of data communications. This protocol requires a great deal of computer processing power in order to perform a data transfer. One major problem is that the wireless device can not tell where the LAP is located and cannot know the correlation of the residence between a LAP and a store unless the wireless device or the device user performs a specific task to figure this out.

To illustrate a practical application that utilizes a PDA, a restaurant may have its waiters use a PDA to take orders from customers and transmit the orders to the kitchen. A preparation cook can then view the orders on a computer screen, saving the waiter a trip to the kitchen to submit the order. Data may also be sent to other locations such as the cashier for producing a bill, a stock manager for tracking inventory, and other locations that may be helpful to the business.

In another example, a cellular telephone may be used to download or upload information, such as photos or text messages. In operation, a user can connect with the cellular network via an interface so configured to send photos and messages. The cellular provider for the phone typically charges for each upload, particularly for photos, and involves connection with a cellular network that can be slow, cumbersome and expensive. However, a user needs to connect to the cellular network in order to upload text or photos at public location.

Using a conventional system, the PDA application would typically open up a TCP connection with the remote computer by specifying the computer's Internet Protocol (IP) address or other identification. Requiring the PDA to know the computer's IP address is burdensome on the PDA and, more importantly, requires the PDA to either contain a large amount of IP addresses or to be reconfigured for every computer to which the user of the PDA wishes to communicate. The operating system of the PDA then opens up a PPP connection using a communication configuration, such as a LAP, or, more specifically, an infrared modem.

The communication operation requires a TCP/IP/PPP protocol data stack stored in the operating system of the PDA. This stack enables the PDA to generate data packets having TCP/IP/PPP headers associated with each packet. Such a header is standard protocol for communication between computers when interacting and sending data from one computer to another. The identification header of the TCP IP is typically 40 bytes of data for every data packet that is transmitted. The IP header is usually 20 bytes in size, and the TCP header is 20 bytes, totaling 40 bytes. In some configurations where compression of the TCP header is used, the TCP's 20 bytes may be reduced to 4 bytes, leaving a header with a total of 24 extra bytes required for each data packet transfer. If PPP protocol is used for encoding, there are 4 extra bytes to add to the header, giving 44 bytes in the standard header, or 28 bytes in a header with a compressed TCP. This requires the use of the PDA's memory capacity, which may be a large burden on the PDA, especially since PDAs are typically small hand held devices. This burden is also a bit unreasonable, since the interaction between the PDA and the computer is typically not an interaction using reciprocal dialog, but merely an operation of uploading and downloading data packets.

Moreover, the protocol lays a tremendous burden on the microprocessor within the PDA, which is typically a small, specialized microprocessor, designed to perform particular tasks. In particular, the AHDLC encoding procedure and the CRC checksum procedure are a large burden on the PDA's microprocessor. Such burdens lessen the ability of a PDA designer to keep the PDA device small, yet still have adequate processing power.

If the AHDLC encoding is used, a PPP header is required. The PPP connection is made by negotiating a communication protocol and channel between the PDA and the computer via the LAP. The PPP header, typically 4 bytes in size, requires an encoding operation to be made to each byte of the entire block of data to be sent. The reason for the PPP connection is that, in conventional communication protocols, bytes 00 hex through 20 hex must be encoded. The reason for this is that, historically, these bytes were used in serial telephone modem communications for control bytes, leaving them unavailable for use as data bytes. So, for example, for every 256 bytes used, 32 of those bytes are not available for use and must be encoded if they are to be used as data. Encoding the bytes differentiates them from the 00 through 20 bytes that may be used for control instructions.

For example, if 1500 byte data packets are to be sent, including the TCP and IP header, the time needed to perform the PPP connection for each data packet transmission is t=[f(x)×1500], where f(x) is the encoding operation. The result of this operation is an extra byte for every byte encoded, giving 3,000 bytes that need to be that need to be operated on. Since 32 of the 256 Hex bytes must be encoded, the extra bytes generated would be approximately [32/256×1500×2]=300. This extra data is a burden on the device memory, requiring more memory space to store the data. It is also a burden on the processor, which must spend the extra time to encode the data, byte by byte, in order to transmit the entire data block. The resulting amount of data is 1500+300=1800 bytes to be transferred from the PDA to the computer or other device.

The CRC checksum operation, part of an error check procedure between devices, also requires a mathematical operation to be performed on each byte of the data packet being sent. For example, if 1500 bytes are to be sent in a packet, 40 bytes make up the TCP and IP header together, leaving 1460 bytes of data to be sent. To send this packet, a mathematical operation must be performed on each byte. This operation may be an add operation, where all of the bytes are added together, or some other operation, f(x), which may depend on the application. The time required for such an operation would be t=[f(x)×1460]. This could be a large burden on the microprocessor, greatly slowing down the data transfer process.

As a result, the extra burden of the TCP/IP/PPP protocol causes the PDA to be slow to process, transmit and receive data, and requires large memory storage and processing components, increasing the size and weight of the PDA.

After the PPP negotiation and connection set-up with the connection is complete, the PDA is assigned an IP address. The PDA can then open a TCP connection with the computer. Referring again to the restaurant application, once the TCP connection is opened, the food order is sent to the computer for processing. Once the order transmission to the computer is complete, the communication connection is deconstructed. In order for the waiter to send another order, a new communication connection must be established, and the process is done again.

Many conventional cellular telephones offer features typically found in PDAs, and even offer interactive services to a user, but their services are seldom relevant or adaptable to specialized wireless device applications. Also, access to a cellular network is limited to the range of the cellular phone system. In most situations, access and support for particular applications can be lacking.

Cellular networks cost money to use, and comparing with wireless or infrared LAN they are less limited in access of broader areas to achieve greater mobile coverage. On the other hand, a venue or a store cannot deliver location specific information to the cell phone through the cellular network while the phone user is visiting the store since the cellular network cannot pinpoint to an exact location of the cell phone unless some human involved procedures—to identify the location and access a particular application, connect to a network, and send and receive information of location specific are taken. The “location” can mean for example a fast food restaurant on xyz street of a city, or a store in a mall, or gate xyz of a terminal of an airport. In many cases, this process can be burdensome to a user. Also, if access is burdensome or time consuming, the user will not bother using convenient services at a particular location, losing out on its benefits. Furthermore, support for an application in a particular and unique location can be unavailable given a user's cellular phone provider and whatever services are provided. Such a system may need weekly, daily, hourly or real time updates and maintenance by people familiar with the business. Cellular service providers, therefore, do not provide such specialized services because they do not have the infrastructure or the expertise required to create and maintain systems capable of providing such services.

Therefore, it would be useful to develop a device and method for more efficiently and intelligently transferring data between a PDA and a computer server that does not suffer from the drawbacks of conventional cellular phone transmissions. Such a system should also be less burdensome on the digital memory storage and the data processor of the PDA, and less burdensome on the user to access specific data according to location. This would also enable a cellular phone to upload content, such as text, photos and other data, without needing to access the cellular network, avoiding the dependence on the cellular network support in order to operate the function. It also enables a cell phone to download content such as coupons of any store without having to enable store specific application or select the store. As will be seen, the invention provides such a device and method that accomplishes these goals in an elegant manner.

### SUMMARY OF THE INVENTION

The invention provides a communication interface that is configured to exchange digital data packets configured with a simplified header format with a wireless device, such as a PDA, a cellular phone configured as a PDA, or other device, and is further configured to exchange digital data configured with a conventional header format with a device such as a computer server communicating with a network, such as the Internet.

In one application, local information can be uploaded and downloaded from a cellular telephone configured to transmit and receive localized information that pertains to a location where a user operates. For example, a user may bring a wireless device, or a cellular phone operating as a wireless device, to a fast food restaurant and beam up menu information, coupons, daily specials, and other information. This information can be viewed by a user before an order is made, and can be interactive in nature. It is also possible for further features, such as questions sent and answers received, actual orders made, updating information, and other features. A remote or local server is utilized to maintain relevant information that is relevant to the location. When this user brings the same wireless device to a store next or near to this fast food restaurant, the wireless device will receive localized information that pertains to the store according to this invention.

When directed to exchange data between a wireless device and a computer, the interface is capable of converting the header of a data packet from one header format to another header format. This allows seamless communication between the computer and the PDA. The typical communication between the PDA and other devices is not interactive, but rather relatively simple data downloads and uploads. Therefore, complex header protocols required for universal communication with other devices, including devices connected to the Internet, are not necessary for a PDA. Using the interface, the complex computations and extensive data storage required to make data transactions can be offloaded from the PDA to the interface. The interface can then perform the direct communication with a computer server or other device that is connected to a network, such as the Internet.

In operation, the communication interface may receive the data packet transmitted from the PDA under the first header format, destined for a computer connected to a network such as the Internet, and convert the header associated with the data packet to the second header format. The interface can then transmit the data packet having the reformatted header to the computer server via the network for processing.

Similarly, the communication interface is further configured to receive the data packet having the second header format and transmitted from the computer server, convert the associated header from the second header format to the first header format and then transmit the data packet having the reformatted header to the PDA. The inclusion of such a communication interface in a computer system reduces the amount of overhead data required to send data to and from the PDA. Employing the interface also reduces the amount of computation required of the PDA to receive and transmit the data. The invention may be extended to include the execution of other complex operations for the PDA for which the PDA may not have the memory or processing capacity. The invention is applicable to all types of PDAs, including cellular telephones configured as PDAs and many other types of devices.

### BRIEF DESCRIPTION OF THE DRAWINGS

FIG. 1 is a block diagram of a system for communicating between a PDA and a computer according to the invention;

FIG. 2 is a block diagram of a PDA configured to operate according to the invention;

FIG. 3 is a block diagram of a communications interface according to the invention;

FIG. 4 is a block diagram of a computer configured to operate according to the invention;

FIG. 5 is a block diagram of a conventional data packet used for data communication;

FIG. 6 is a block diagram of a simplified data packet used according to the invention;

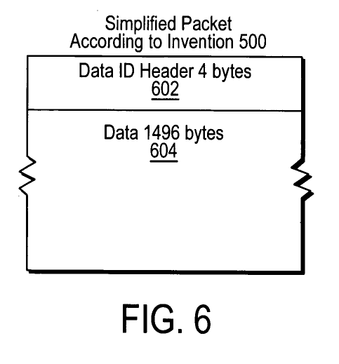

FIG. 7 is a flow chart of a process for transmitting data from a PDA to a computer according to the invention;

FIG. 8 is a flow chart of a process for transmitting data from a computer to a PDA according to the invention;

FIG. 9 is a flow chart of a process for transmitting data from a computer to a cellular telephone configured as a PDA according to the invention; and

FIG. 10 is a flow chart of a process transmitting localized information from a computer to a wireless device according to the invention

### DETAILED DESCRIPTION

The invention provides communication interface for enabling communicating between a personal data assistant (PDA) and a device connected to a network such as computer server. Typical communication between the PDA and other devices is not interactive, but rather relatively simple downloads and uploads of data packets. Therefore, according to the invention, complex header protocols required for universal communication with other devices, including devices that communicate via the Internet, are not necessary. To this end, a communication interface is provided for performing the complex header protocols for the PDA, with the communication interface acting as an interface between the PDA and other conventional devices. The communication interface may have an IP address associated with the PDA so that it may send and receive transmissions of data on its behalf. This way, any device connected to the Internet can send the PDA data. The interface may then intercept such data transmissions and process them according to the invention. Thus, the PDA may operate entirely transparent to the devices that transmit data packets to it.

The use of a simplified header format for transferring and receiving data packets and a system that can communicate using the simplified format is provided. The simplified header may simply have basic information pertaining to the data being sent, such as size, sequence of data if transferred among a number of packets, destination address, identification of the communication interface, or different combinations and permutations of such information. A packet may be sent with simply a destination address and accompanying data. In using the simplified format, less memory capacity is required of the PDA as well as less processing capacity to prepare and send the data packets. The interface may be configured to communicate with PDA by receiving data from the PDA and sending data to the PDA under a simplified header format, the simplified format being simplified relative to conventional TCP/IP/PPP header format. The interface may include a storage device for storing data and a wireless data transceiver for receiving data packets from and transmitting data packets to the PDA, where the data packets are configured under the simplified format. Accordingly, the PDA may include a similar transceiver configured to receive data packets from and transmit data packets to the interface.

According to the invention, the interface may also be configured to communicate with a device connected to a network, such as a computer server, that is configured to send, receive and process data formatted under a second header format that may be different than the simplified format. The interface may act as a central header translator that is configured to receive digital data to and from the PDA configured under a first header format, then translate the first header format to a second header format. The interface may then send the data configured under a second header format to the computer server. In operation, the device may receive the data transmitted to it by the PDA and convert it from the first header format to the second header format. The device may then transmit the reformatted data packet to the computer server for processing. The device may then receive the processed data transmitted from the computer server, convert the data packet back to the first header format, then transmit the again reformatted data packet back to the PDA.

The invention may include the utilization of dedicated processors, webservers configured to receive and route browser requests, application servers, state servers and other types of computer processors. These devices may be configured to communicate amongst each other and may be connected to one or more networks, including a Local Area Network (LAN), an intranet and the Internet. These networks may also include the use of wireless as well as wire line connections in order to communicate. However, it will be appreciated by those skilled in the art that such implementations of devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although the embodiments described and illustrated herein are in the context of devices and systems for exchanging data among users of a computer system or network and users of PDAs, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers and PDAs connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. In devices such as PDAs, it is important that processors are physically small enough to help keep the PDA itself small, yet powerful enough to be able to perform the tasks required to make the PDA useful for sending, receiving and using data. It is these goals that a device embodying the invention may achieve.

The software code utilized in the PDAs and other devices utilizing the invention may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of devices, such as specialized computer servers and PDAs, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively. In devices such as PDAs, it is important that such memory devices are physically small enough to help keep the PDA itself small, yet contain enough storage space required to make the PDA useful for sending, receiving and using data. It is these goals that a device embodying the invention may achieve.

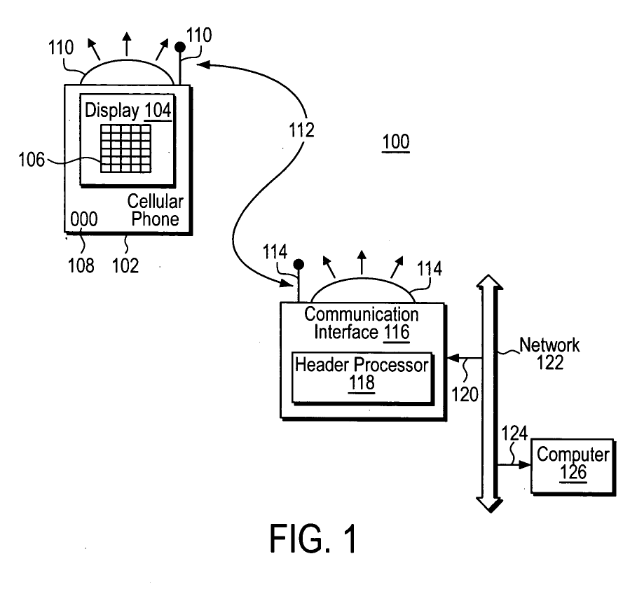

Referring to FIG. 1, a block diagram of a system having a device configured to enable communication between a PDA and a device connected to a network according to the invention is illustrated, in this embodiment a computer server connected to a network such as the Internet. The PDA 102 includes graphical user interface (GUI) 104 for displaying content 106 to a user. The PDA may also include manual control switches or knobs 108 for inputting data into the PDA, but may also be configured with a touch-sensitive screen or other type of data input mechanism for inputting data into the PDA. The PDA may also include means for transmitting and receiving data such as an antenna 110 connected to a transceiver (not shown in FIG. 1). Such an antenna may be internal to the device, not visible to a user during normal use. The transceiver may operate as a laser light device, a radio frequency (RF) device, or other type of communication mechanism configured to send and receive data between the PDA and some destination. The primary purpose of such a device is to provide a portable hand-held device for sending and receiving data between the PDA and another remote device.

The PDA may be configured to communicate via a signal 112 with a similar transceiver connected to an antenna 114, which is connected to communication interface 116. The interface transceiver may be configured to operate in the same manner as the PDA's transceiver. One purpose of the communication device is to provide a mechanism for enabling efficient and improved communication between the PDA and another device. This is accomplished by reducing the amount of data sent by and received from the PDA as well as the computations required for such data transactions in the normal use and operation of the PDA. The communication interface may include a header processor 118 that is configured to manage header information that is transmitted between the PDA and the communication interface. One way that it may accomplish this is by reducing the amount of header data that is typically transferred to the PDA by reformatting and simplifying the conventional TCP/IP/PPP header to a smaller, efficient and more manageable header. This obviates the PDA's need to process and store the conventional header. The communication interface may also be configured to receive data that is transferred from the PDA in this simplified format, reducing the amount of header data transmitted by the PDA. As a result, this also reduces the amount of processing required by the PDA to transmit such data, such as the processing that is typically required to transmit data using conventional headers. This is described in more detail below. The common format for conventional data communications with PDAs is the TCP/IP/PPP protocol. When communicating between a PDA and a computer, the TCP/IP/PPP protocol is typically used. When communicating between a computer and other conventional devices, a TCP/IP is typically be used. Other standard data formats configured for universal communication may be used, but would not depart from the spirit and scope of the invention. This conversion may involve the conventional communication operations discussed above. One of the advantages of the invention over the prior art, however, is that these operations can be performed by a communication interface rather than the PDA, relieving it of this burden.

Still referring to FIG. 1, the communication interface 116 may be configured to communicate through a communication channel 120 with a network 122. The communication channel may be a telephone landline, an Ethernet connection, or any number of communication mechanisms, whether constructed with electronic hardware or some type of wireless application. The Network may be a LAN, an intranet, the Internet, or some other type of mechanism that allows computers and other data processing devices to communicate amongst themselves. The network may also communicate via a second communication channel 124 with a computer 126. This allows a means for the communication interface to communicate with the computer.

In operation, the PDA 102 may process data, convert the data into a signal 112 and transmit the signal to the communication device 116. The data is sent in separate packets, which may be of uniform or varying size. These packets may include a header having a predetermined format that is a specialized format configured to optimize the data transfer. The communication device may then convert the header format of the received data to a conventional TCP/IP header. This allows the data to be transferred along conventional channels, such as the network 122, to conventional devices, such as computer 126. The computer can then process the data and then return it along the reverse path back to the PDA.

This system optimizes the operation of the PDA in several steps. One step is the transfer of data from the PDA to the communication interface. As discussed in the background, conventional devices communicate using the conventional protocol, which requires a large amount of processing prior to transmitting data. This processing also generates more data that must be transmitted along with the large header as well as the actual data. The communication interface takes this burden off of the PDA by converting the simplified header to a formal conventional TCP/IP or other header. The data can then be processed or sent to other devices in remote locations, such as the computer 126. At this location, the computer is able to perform complex operations on the data that may be overly burdensome for the PDA. For example, a user of a PDA may want financial projections on a transaction. The user could send the basic information to the computer via the communication interface. The computer, having extensive processing power, could perform the complex operations and then transmit the result data back to the PDA via the communication interface for use by the PDA's user. According to the invention, these new features provided by the system effectively give virtually limitless remote processing power to the PDA, and actually reduce the processing and data storage burden on the PDA at the same time.

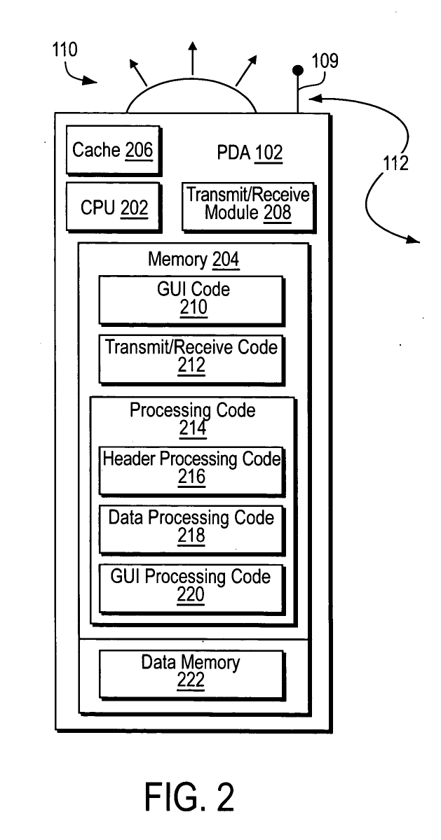

In order to understand the operation of the invention, it is useful to understand the components in more detail. Referring first to FIG. 2, a more detailed illustration of a PDA 102 is shown. The PDA typically includes a central processing unit (CPU) 202 that is configured to execute software commands and perform PDA functions according to the command instructions that may be received from an outside source. These commands may be stored in main memory 204 or cache memory 206. Such functions may include the transmission and reception of data, graphical user interface operations, data processing operations, data security functions, and other functions that may be related to the operation and use of a PDA. The PDA typically includes some type of transmit/receive module 208, which may be a transceiver that performs both sending and receiving operations, or separate components for transmitting and receiving data. The module may be connected to an antenna 110 for sending and receiving electronic signals 112.

The PDA may include a main memory 204 having software code and data stored therein. The software code may be executed by the CPU 202, and may govern the operations and functions of the PDA. The PDA may also include cache memory 206 for storing data frequently used by the CPU. In some applications, the PDA may be configured to store software from the main memory into the cache memory in order to give the CPU easier access to the data for execution. Graphical user interface code 210 may be executed by the CPU to control the PDA's display 104 (FIG. 1). The code used would likely be unique to the application used for the graphical display, such as a light emitting diode (LED) display, a quartz display, or other type of display. Many types and implementations of displays are well known to those skilled in the art of PDA design as well as other similar technologies. Transmit and receive code 212 may also be included in the PDA main memory. Upon execution by the CPU, the transmit and receive code enables the CPU to cause the PDA to transmit and receive data with the transmit and receive module 208. The memory may further include processing code 214 for processing instructions and data related to processing headers, data, GUI instructions and data, and other instructions.

The processing code may include header processing code 216 configured to change headers among different formats according to the invention. As discussed above, the invention provides a method and apparatus for optimized transmission of data between the PDA and a communication interface. The PDA simply sends data packets having reduced headers in order to reduce the computation needed to prepare and send the data. The data is simply sent with minimal information. The header information may include the IP addresses of the PDA and the destination device for identifying the source and destination of the information. The header may also include the file name, the file size, the sequence of the data packet in relation to other data that has been sent, and other information related to the data, of different combinations and permutations of such information. Of course, the packet may also include the data itself, which may be referred to as payload data.

The header accompanying data within a packet may be configured according to a standard protocol such as the IrDA Object Exchange Standard, or IrOBEX, developed by the Infrared Data Association™, a copy of which is attached. The invention, however, is not limited this protocol, but extends to other configurations that allow a data packet to be configured with limited header information. Such a data packet may include the minimal amount of information that is required to transmit data from the PDA to the communication interface, such as the name of the file being transferred and the beginning and end of the data. Importantly though, according to the invention, the header used for transmission between the communications interface and the PDA is much more simple than complicated header information such as that required under the TCP/IP/PPP protocol data, which is commonly used in conventional data transmission applications.

This simplified header saves much computation in the transmission of data from the PDA.

For example, in the data transmission operation between the PDA and the communication interface, a first packet may be sent that identifies the name and size of the data file to be transferred. A second packet may then be sent having a header that identifies what part of the whole file is being transferred and the size of the particular portion being transmitted within the second packet, specifying the beginning and the end of the portion being transferred. However many packets that are needed to transfer the data are transmitted until the entire file has been completely transferred. The final packet may then specify the end of the file, indicating that the entire packet has been transferred to the destination. The transmission of data in this manner may be done in both directions, from the PDA to the communications interface as well as from the communications interface to the PDA. In either case, the transmission of data is greatly simplified in order to lighten the processing load on the PDA. This method also reduces the amount of storage space is needed in the PDA and greatly reduces the transmission time of data transmissions. This also relieves the PDA from having to keep a TCP/IP/PPP protocol stack in its memory.

Still referring to FIG. 2, the PDA may also include data processing code 218 stored in its main memory 204 for performing the processing of data within the PDA when the CPU executes the code. According to the invention, many data processing functions may be performed remotely, sparing the PDA of the processing burden. This allows the PDA to run more efficiently and require less powerful processing circuitry. The PDA memory may also include GUI processing code for performing general GUI functions when executed by the CPU. The main memory may also include data memory for storing data to be used or transmitted by the PDA.

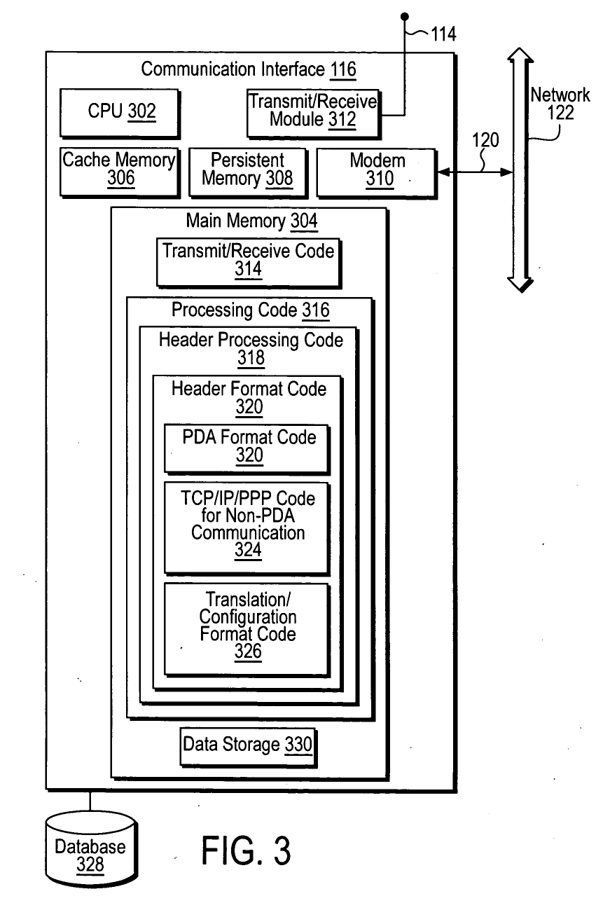

Referring to FIG. 3, further details of the communications interface 116 are shown. The interface may include a CPU 302 configured to execute software code stored in main memory 304 for performing internal operations of the interface. Optional cache memory 306 and persistent memory 308 may also be included in the interface to provide alternative storage locations to optimize access to data by the CPU. The interface may also include modem 310 that allows the interface to communicate with network 122 via communication link 120 as discussed above. This enables communication with other devices on the network such as computer 126 of FIG. 1. Transmit and receive module 312 may also be included for facilitating communication between the interface and the PDA, and the module may be connected to antenna 114. The module may be a transceiver, performing both transmit and receive functions, or the two functions may be divided into two separate modules. The transmission module may be a radio frequency module, configured to send and receive RF signals. The module may also be an infrared LAN (local area network) access point (LAP) for receiving and sending infrared signals when communicating with a similarly equipped and configured PDA. The invention is not limited to a particular type of interface between the PDA and the communication interface.

The interface includes a main memory 304 for providing main storage of data and software code required for the operation of the interface. Transmit code 314 may be included to allow the interface to perform transmit and receive functions when the code is executed by the CPU. According to the invention, the code can be designed to configure the interface to sent and transmit data having a simplified header, without any TCP/IP/PPP headers, with similarly configured PDAs.

The interface may also include processing code 316, which, according to the invention, configures the CPU to perform data processing and instruction execution when the CPU executes the code. The code may include header processing code 318. The processing code includes executable software code for performing the header format configurations. These configurations may be used in facilitating communication between the PDA and the computer. Header format code 320 is configured to process headers of data packets by configuring them with the proper format according to the intended destination of the data packet.

For example, a data packet originating from the PDA and destined for the computer may have a simplified header as discussed above. The CPU may reconfigure this data packet when it executes the PDA format code 322. This code would allow the CPU to separate the data from the header so that it can be reconfigured. The translation and configuration format code 326 may then translate the header information pertaining to the data transmission from the simplified format to TCP/IP format. The reconfigured data packet can then be retransmitted to the computer using the transmit and receive code 314. If communicating with another PDA, the communication interface may retransmit a data packet with a simple header to another PDA. Or, if the packet is destined for other PDAs that are not so configured, it may transmit data using a TCP/IP/PPP header. This would make the communication device universally compatible with multiple communication devices.

Similarly, a data packet originating from a computer 126 and destined for the PDA 102 may have a header configured in the TCP/IP format. The TCP/IP code 324, when executed by the CPU, would allow the header to be separated from the data. The header can then be reformatted from the TCP/IP header format to the simplified format by executing the translation and configuration format code 326 with the CPU. The newly configured data packet can then be transmitted to the PDA whey the CPU executes the transmit and receive code 314.

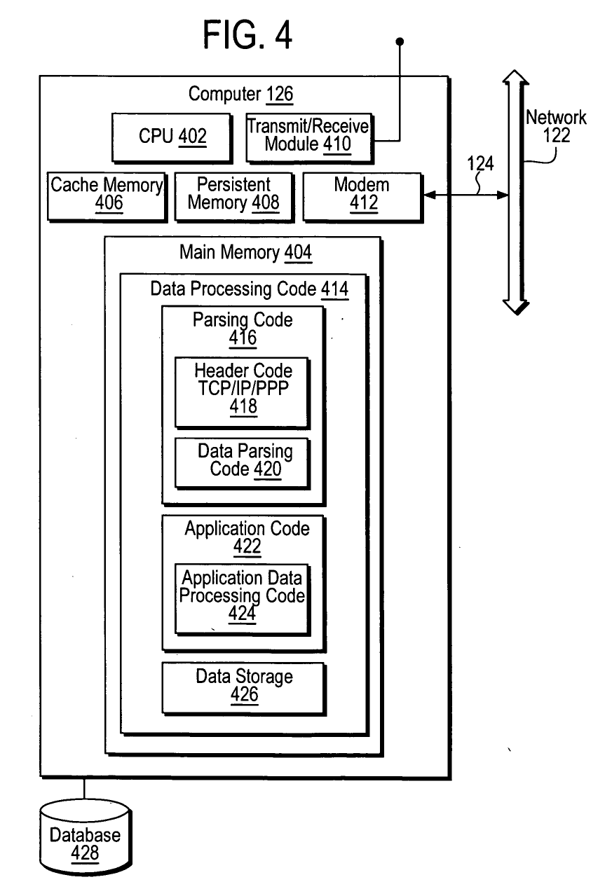

The computer, 126, may be any type of data processing device such as a personal computer, wireless data communication device, or any other device that communicates by sending data packets configured with headers having TCP/IP format. According to the invention, a PDA is able to communicate with such computers via the communication interface without having to deal with TCP/IP and TCP/IP/PPP header format operations. Referring to FIG. 4, a more detailed block diagram of a computer is shown. The computer may include a CPU 402 configured to perform standard processing operations of the computer when it executes software stored in main memory 404. The computer may also include cache memory 406 and persistent memory 408 for providing more efficient access to data and command instructions to the CPU for execution.

In an alternative embodiment of the invention, the computer may include the functions of the communication interface 116. The computer would then include substantially all of the processing code 316 and transmit and receive code 314, FIG. 3. The computer would then need a transmit and receive module 410 for communicating with the PDA in the same manner as the communication device 116 does with its transmit and receive module 312. In such a configuration, the communication interface is built in to the computer, obviating the need for a separate device.

The computer may further include data processing code 414 that includes code that configures the CPU to perform data processing tasks. The code includes parsing code 416. The parsing code may cause the header to be parsed out from a data packet when the CPU executes the TCP/IP header code 418. Data may also be parsed out from a data packet by executing the data parsing code 420 with the CPU. Once the data is separated from the header, the computer may store the data in data storage 426 and process the data by executing the application data processing code of application code 422.

The application code may be code configured under any one of a number of applications wherein data may be used, processed or otherwise consumed. These applications may be used as remote operations to the PDA, giving it extra processing power that can be performed by the computer. For example, the user of a PDA may wish to attach and send a document or other large data attachment to an email for transmission via the Internet. The PDA being limited in size and, consequently, limited in memory and data processing capacity, it would be a large burden for it to have the document stored and processed in the PDA. According to the invention, in response to a request sent from the PDA, a document stored on the computer is capable of being attached to an email and transmitted to an email recipient. The capacity of the computer may be utilized in numerous ways to offer expanded memory and processing capacity to the PDA remotely. This capacity may also be provided to the PDA by the communication interface 116. The interface may be equipped in the same manner as the computer as described herein to provide remote processing and data storage functions.

The computer may also include a database 428 containing data for use by the computer 126. According to the invention, the PDA may be able to access the database attached to the computer by sending data packets containing instructions to do so. Using this technique, the PDA is able to perform processing and transmission of data that would normally be burdensome to the PDA performing these tasks by itself.

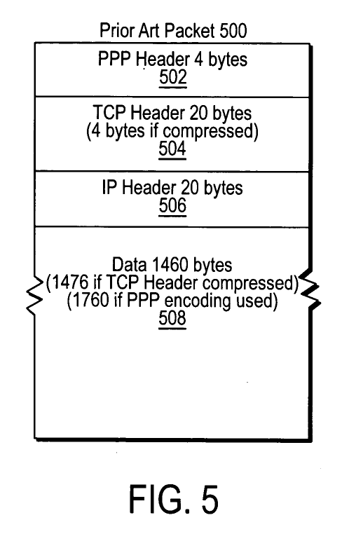

In operation, the presence of the communication interface allows the PDA to greatly simplify data transmission as well as computations that are regularly performed by the PDA in normal use. According to the invention, the communication interface also greatly expands the PDA's capabilities without requiring any improvements in processing capacity or data storage capacity. Referring to FIG. 5, an example of a data packet used in the prior art is shown. As can be seen, transferring data at 1500 bytes for each packet can take up to 44 bytes of space from the packet for the header alone. The PPP header 502 takes up 4 bytes, the TCP header 504 takes up to 20 bytes (4 bytes if compressed), and the IP header takes up 20 bytes, for a total of up to 44 bytes. If PPP encoding is used, the data packet is increased by approximately 300 more bytes, which may be required to be transferred with the encoded data. As discussed in the background, this lays a heavy burden on the PDA. In contrast, the data ID header 602 in the simplified packet takes up much less memory space, as little as 4 bytes for a packet of 1500 bytes in this example. This leaves much more data, 1496 bytes of data 604.

In practice, an implementation of one embodiment of the invention included a PDA sending data using an OBEX formatted header, a header format that is much more simple than the TCP/IP/PPP protocol, to a communication interface. The implementation was tested, resulting in a data transfer of 5.5 kilobytes per second. This is an almost 300% improvement of an equivalent data transfer using TCP/IP/PPP headers in the data packets transmitted from and sent to the PDA. This result is an example of the utility of the invention in practical use.

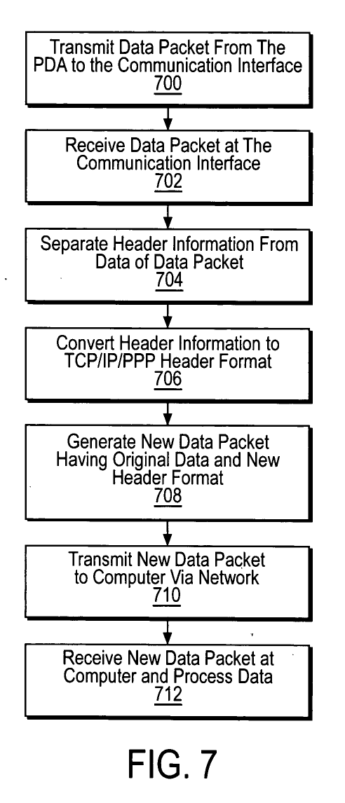

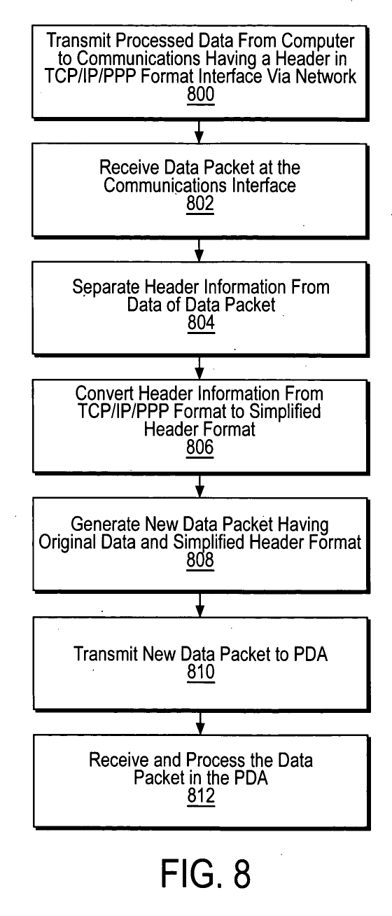

To better explain the operation of one embodiment of the invention, reference is made to FIGS. 7 and 8, which will now be explained. Referring first to FIG. 7, a transmission of a data packet from a PDA to a computer is illustrated. In the first step 700, a packet of data is transmitted from the PDA to the communication interface. The packet will have been formatted in a simplified format to simply identify the data size, the source of the data, the destination, the type of data, the number in a sequence of data packets if there are more than one, and other basic information required for the communication interface to identify and process the data packet. As discussed above, since this is a simple data download, complex header protocol, such as TCP/IP/PPP, that would require extensive processing by the PDA, is not required. Such complex header protocol may also cause the data to be transformed in the process, which would require undoing at the destination in order to further process or otherwise use the data.

In the next step 702, the data packet is received by the communication interface for processing of the header information. The first step in this procedure is to separate the header information from the data itself in step 704. Since same data is being sent to the computer, only the header information needs to be converted to a new format. The next step, step 706, is to convert the header information into the standard baseline communication format. As discussed above, the common format for data communications is the TCP/IP protocol. Other standard data formats configured for universal communication may be used, but would not depart from the spirit and scope of the invention. This conversion may involve the conventional communication operations discussed above. One of the advantages of the invention over the prior art, however, is that these operations can be performed by a communication interface rather than the PDA, relieving it of this burden. The interface may then generate a new data packet in step 708, again possibly performing conventional TPC/IP operations for formatting the header, encoding the data, etc.

The data packet may then be transmitted to the computer via the network in step 710. This is possible because the data packet at this point has a header configured under the standard communication protocol required for transmission over the Internet. All of this can be completely transparent to the computer. The computer may then receive the new data packet in step 712 and process the data contained therein. The computer may never be able to detect whether the data packet was sent by a PDA under a different header format or by another computer or other device that the computer may recognize. According to the invention, it never needs to know.

Referring now to FIG. 8, the procedure for transmitting data from the computer back to the PDA is illustrated. The process begins at step 800, where the data processed by the computer is transmitted to the communications interface via the network. This data packet may have a header configured under the TCP/IP protocol, so that it can be sent to the interface via the Internet. The communication interface may then receive the data packet in step 802. The communication interface may have an IP address associated with the PDA so that it may send and receive transmissions of data on its behalf. This way, any device connected to the Internet can send the PDA data. The interface may then intercept such data transmissions and process them according to the invention. The PDA may then operate entirely transparent to the devices sending it data packets.

The interface may then separate the header information from the data and convert the header in step 806 from the TCP/IP protocol to the simplified header as discussed above. The data can then be associated with the new simplified header in step 808 as the interface generates a new data packet. The interface can then transmit the new data packet to the PDA in step 810. The PDA can then receive and process the data packet in step 812, completing the process.

In another embodiment, the invention provides a useful device and method to use a hand held wireless device, such as a cellular phone, to upload and download information locally without needing to access the cellular telephone network. Though cellular phone service providers offer different products and services, their services are seldom relevant or adaptable to specialized wireless device applications. Also, regardless of the capacity of the wireless device, access to a cellular network is limited to the range of the cellular phone system. In most situations, access and support for particular applications can be lacking.

Cellular networks cost money to use, and comparing with wireless or infrared LAN they are less limited in access of broader areas to achieve greater mobile coverage. On the other hand, a venue or a store cannot deliver location specific information to the cell phone through cellular network while the phone user is visiting the store since the cellular network cannot pinpoint to an exact location of the cell phone unless some human involved procedures—identify and access a particular application program on the cell phone, connect to a network, and send and receive information, are taken. The “location” can mean for example a fast food restaurant on xyz street of a city, a store in a mall, or gate xyz of a terminal of an airport. In many locations, access using the cellular phone system can be burdensome to a user. For example, if a user is in a fast food restaurant, the daily menu, specials, coupons, and possibly ordering information may be available to a wireless user for convenience. A user may be able to avoid waiting in line by ordering and even paying for a food order using the wireless device. Unless access and support are available, the user is left to wait in line. Also, if access is burdensome or time consuming, the user will not bother using this convenient service, losing out on its benefits.

Furthermore, support for an application in a particular and unique location can be unavailable given a user's cellular phone provider and whatever services are provided. A business may need a robust system to provide services. Such a system may need weekly, daily, hourly or real time updates. The system may need maintenance by people familiar with the business, and would therefore need to be accessed, updated and maintained outside the cellular phone network. This would be difficult for a cellular service provider to provide given conventional systems available.

If, however, the restaurant has a system available that is configured according to the invention, such service is possible without the need of a cellular network. Information can be beamed to and from the wireless device, or cellular phone configured as a wireless device. The information exchanged could be local in nature, and the transmission can be performed with local hardware, again, without the need of the cellular network. Transmissions can also be shared with a local server, where transmissions from a user can be processed. They can also be shared with other devices via networks, such as the Internet, where application servers are located and maintained remotely from the contact locations. An application server can be configured to communicate with an interface, where the server processes transmissions occurring between wireless devices and the interface, enabling convenient local services for wireless users.

In many conventional wireless or mobile devices, cellular phones, PDAs and other devices, the web browser used to access the Internet typically uses HTTP protocol to access the Internet. Conventional IR and/or Bluetooth equipped PDA or cell phone support the OBEX protocol. The invention defines algorithms for mobile devices to access the Internet using the OBEX protocol instead of the cellular network to upload information from a wireless device and download to a device.

In one application of the invention, local information can be uploaded and downloaded from a cellular telephone configured to transmit and receive localized information that pertains to a location where a user operates. For example, a user may bring a wireless device, or a cellular phone operating as a wireless device, to a fast food restaurant and beam up menu information, coupons, daily specials, and other information. This information can be viewed by a user before an order is made, and can be interactive in nature. It is also possible for further features, such as questions sent and answers received, actual orders made, updating information, and other features. A remote or local server is utilized to maintain relevant information that is relevant to the location. When this user brings the same wireless device to a store next or near to this fast food restaurant, the wireless device will receive localized information that pertains to the store according to this invention.

In one embodiment, HTTP is the protocol used by a client, a web browser for example, to access the resources of a remote server. It uses a URL, the name or IP address of the remote machine and a file name to identify the resource. In operation of one embodiment, an algorithm uses OBEX protocol to enable a device with IR and/or Bluetooth communication capability to access the Internet resources. The client applications within the wireless device use a URL to specify what Internet resources they are interested in. The user further specifies what methods to take (e.g. GET, PUT, or POST) for accessing the resources. An OBEX object is formed when the request is made. The URL string is kept in the name header of OBEX object and the data (if any) is embedded in the object's body. The object is submitted to the OBEX server through OBEX protocol.

The OBEX server examines the URL in the OBEX name header and the method is applied accordingly based on the scheme specified in the URL. For example if the name header in the OBEX object is http://www.xyz.com/index.html and the method was OBEX GET, the OBEX server will issue HTTP GET for the index.html file on the www.xyzcompany.com server. If the name header is ftp://myname:mypassword@ftp.xyz.com/mypicture.gif and the method was OBEX PUT, the OBEX server will issue FTP PUT to put the mypicture.gif file on the www.xyz.com server.

For illustration, and as another example, the syntax of a URL can be:
<scheme>://<user>:<password>@<host>:<port>/<path>?<query>#<frag>
   In utilizing this URL according to the invention, there are a number of methods defined in HTTP. The POST method allows the client to send data to a server for processing, for example user name and password to the server. Upon receiving the POST method from the client, the server checks and verifies the user name and password and sends the proper response back to the client. The response could be a simple statement such as “OK, you are logged in”, a picture, an MP3 file, or other indicator. Another method, GET, works in a similar manner as the POST method. It is used for the client to get data from a server. A HTTP PUT method means the client wishing to send and store a file to the server. HTTPS is the HTTP protocol with SSL encryption. Thus, HTTP is used interchangeably as both HTTP and HTTPS.

As still further background, all of the IR and Bluetooth enabled cell phones support IrOBEX, which is a protocol developed by IrDA (www.irda.org) and later adopted by Bluetooth. The design of the protocol is to enable easy object exchange between 2 IR or Bluetooth devices, where the object could be a business card, calendar and so on. The IrMC specification defines a group of objects that are supported using the OBEX protocol, vCard for business card and vCalendar for calendar for example.

OBEX defines a number of commands. Among them, the PUT command is to send an object to another OBEX enabled device. Another command, GET, is to instruct the other device to retrieve an object from its local storage and send it back. For the object of the PUT command, it is a file of the local storage (file system or memory). For the object of the GET command, it is a file of the other devices local storage. For example, a client issues an OBEX PUT command with file name my_card.vcf means the client is sending a vCard file my_card.cvf to another device. Another example, a client issues an OBEX GET command with file name your_card.cvf means it is telling the other device to send a file called “your_card.cvf” to the client.

In one embodiment, the invention provides a method for employing an algorithm generally as follows: OBEX PUT→HTTP PUT or HTTP POST. This algorithm defines how to map OBEX PUT command to either HTTP PUT or HTTP POST. A client issues an OBEX PUT command and the algorithm translates it to either HTTP PUT or HTTP POST. The client is usually a mobile device, PDA, cell phone and so on. The execution of the algorithm resides in an IR or Bluetooth access point. The mobile device communicates with the access point by either IR or Bluetooth using the OBEX protocol. The access point communicates with a server on the Internet using HTTP protocol. The name header of the OBEX PUT command could be a URL such as http://www.abcd.com/cards/my_card.cvf.

If the client is issuing an OBEX PUT wishes to do a HTTP PUT, a straight mapping is used. The file name that accompanies the OBEX PUT command will be used in the HTTP PUT request. For example, the client issues “OBEX PUT my_card.cvf” the algorithm translates it to “HTTP PUT my_card.cvf”.

| | |
|---|---|
| OBEX Operation: | OBEX PUT |
| OBEX Name Header: | http://www.abcd.com/cards/my_card.cvf |
| OBEX body: | the content of my_card.cvf |

Will be translated into

| | |
|---|---|
| HTTP Method: | HTTP PUT |
| HTTP URL String: | http://www.abcd.com/cards/my_card.cvf |
| HTTP payload: | the OBEX body which contains the content of |
| | my_card.cvf |

If the client issuing an OBEX PUT wishes to do a HTTP POST, the algorithm specifies that the client should put a special character in front of the URL string, a # sign, for example. This special character, # sign, is not limited to one character and can either be inserted in the front of the URL string or attached at the end of the string. The main purpose of this is not to disturb the original URL string and be able to let the OBEX Server to distinguish the difference from a standard URL string. The file name is usually a program on the server that the client wishes to execute. For example, if the URL is www.abcd.com/demo/login.asp, it means the client wishes to log into the application server and the server executes the program login.asp. In this example, the client issues an OBEX PUT command and the name header contains
“#http://www.abcd.com/login.asp”; the body of the object is

“name=john&password=letmein”.

| | |
|---|---|
| OBEX Operation: | OBEX PUT |
| OBEX Name Header: | #http://www.abcd.com/login.asp |
| OBEX Body: | name=john&password=letmein |

Will be translated into

| | |
|---|---|
| HTTP Method: | HTTP POST |
| HTTP URL String: | http://www.abcd.com/login.asp |
| HTTP Payload: | name=john&password=letmein |

According to the invention, another algorithm is used for response handling. HTTP methods can generate a response sent to the requesting client. The issuer (client) of the HTTP method receives the response from the server indicating either success or failure or data the client intended to get. For example, the response of the “HTTP GET a_song.mp3” command is “MP3” music. If HTTP POST is used, the client is expecting response back from the server. Unlike HTTP, there is no way for OBEX PUT command issuer to receive the response from the server since OBEX PUT sends data only.

According to the invention, an algorithm specifies how to receive the response from HTTP server using OBEX. In order to receive the HTTP response from the server, the client issuing the OBEX POST command is required to issue an “OBEX GET RESPONSE” command, where RESPONSE is the file name to get, all capital letters, to the access point. Upon receiving the “OBEX GET RESPONSE” command the access point sends the response from HTTP server to the client.

| | |
|---|---|
| OBEX Operation: | OBEX PUT |
| OBEX Name Header: | #http://www.abcd.com/login.asp |
| OBEX Body: | name=john&password=letmein |

Will be translated into

| | |
|---|---|
| HTTP Method: | HTTP POST |
| HTTP URL String: | http://www.abcd.com/login.asp |
| HTTP Payload: | name=john&password=letmein |

And, the response from the application server can be retrieved by the mobile device using OBEX GET RESPONSE:

| | |
|---|---|
| OBEX Operation: | OBEX GET |
| OBEX Name Header: | RESPONSE |
| OBEX Body: | none |
| Or | |
| OBEX Operation: | OBEX GET |
| OBEX Name Header: | cfs://get/response |
| OBEX Body: | none |

In this example, the file login.asp is the script on the application server authenticating users. The application server receiving the HTTP POST command verifies the user name and password and sends the account information back. The account information is stored in the access point temporarily. The client issues the following OBEX GET command to the access point and thus receiving the account information:
CFS: //get/response
   In another embodiment, another algorithm is used to map the Application ID to a URL.

The syntax of URL is
<scheme>://<host>:<port>/<path>;<parameters>?<query>#<frag>

For example, scheme, host and path could be

| | |
|---|---|
| Scheme | http, https, ftp, smtp, . . . |
| Host | www.yahoo.com; www.abc.com; www.cnn.com; . . . |
| Path | Directory_1/directory_2/directory_3/. . ./login.asp |

The combined length of scheme+host+path could be very long. The problem is that it may be difficult for some mobile devices to support the long URL string. This is because a URL uses a large amount of space for use in the name header to be transmitted in an OBEX command. And, another problem is that the URL could change over time. For example, if for some reason the application server decides to move the login.asp in the above example to somewhere else, the client application in the mobile device needs to be notified the change. Otherwise, the client application won't be able to login once login.asp is moved.

According to one embodiment, the algorithm defines an application ID, a special character, such as the ! sign, a # sign, or any particular character that is not used in the <user>:<password>@<host>:<port>, followed by a number of characters, six numbers for example, that maps to a specific URL. In the example of mobile device and access point, the mapping is stored in the access point. Upon seeing the ! sign followed by a known 6 characters, the access point translates it into an URL. For example, let's say “ABCD35” is a known application ID to the access point and the corresponding URL is “www.abcd.com/dir_{—}1/dir_{—}2”. When mobile device sends an OBEX PUT command with file name “http://!ABCD35/login.asp”, the access point will then translate it into a HTTP PUT request: http://www.abcd.com/dir_{—}1/dir_{—}2/login.asp.

In one embodiment, the invention provides an algorithm to define a way for one application to identify the location where the application is running.

For example, assuming ABCD is a nation wide chain store, each of the local ABCD store may offer a coupon to attract customers. The coupon, containing information related to the item on sale, can be determined by the local store, thus different local stores could offer different coupons. A mobile device may have installed a “Get Coupon” application from ABCD's main web site. And, all the local ABCD stores may have network connections to ABCD's main application server. At a local store, using conventional approach, the user needs to enter the location of the store or the store's branch number into the “Get Coupon” application so that ABCD's main application server can send out the correct coupon to the user. Finding and entering the correct store location or branch number could be very inconvenient for the user. This algorithm solves the problem of how the “Get Coupon” application determines where the user is located and how to retrieve the correct coupon of the local store. As a further extension, the user may go to a non-ABCD store, for example a XYZ store, without having to be aware of the user's location, i.e., the user will not need to worry about determining whether “now, I am in XYZ store and I have to launch an application that associates with XYZ store”. Instead, according to the invention, the user may launch the same “Get Coupon” application used in ABCD store on the mobile device. A system configured according to the invention will find the correct server to seamlessly and almost invisibly provide information localized for this XYZ store. That indicates that the mobile device user will only have to know his/her objective, for example, to get a coupon by the functionality of Get Coupon, where the user is simply concerned with making connection regardless the user's the location. Thus, the URL address in the wireless device can operate as a dummy address that does not necessarily need to match with the user's location.

This algorithm defines that the location and related localized information to be stored in the access point. This localized information is to be sent together with user's request. Referring back to the previous login example, an illustration of this algorithm is best understood by way of example. The localized information “store=ABCD&location=SFO&branch=3940” is stored in the access point. The information says the store is ABCD, location is SFO and branch number is 3940. The user sends out OBEX PUT command to the access point with file name
#http://www.ABCD.com/login.asp
   The access point sees the # sign knowing it should send out a HTTP POST command and it will combine the localized information and send
http://www.ABCD.com/login.asp? store=ABCD&location=SFO&branch=3940
   to the application server www.ABCD.com. The program login.asp will be executed by the application server and with the parameters in the URL, the application server knows exactly where the user is at and the correct coupon could then be sent to the user.

In one embodiment, the invention provides an algorithm to define another way for one application to identify the location where the application is running.

In conventional systems, URLs are of two types, absolute and relative. An absolute URL includes all the information needed for accessing a resource. The information in a relative URL is incomplete. A typical client application (e.g. a web browser), must resolve the relative URL before sending out the request for accessing the resource. According to the invention, the client application do not need to resolve the relative URL if the localization is desired. Thus, an algorithm configured according to the invention supports access to localized resources.

If the URL in the OBEX name header contains no server location and/or path information, the default information in the access point is used. The request is then passed to the associated server location.

Different access points may have different default information (URL destination). For example, the access points in store A may have the default information set to “www.company_{—}11.com/branch7”, in store B have “www.company_{—}33.com/branch66”, and in store C have “www.company_{—}11.com/branch23”. Thus, according to the invention, it is not necessary to specify the location of the application server in the header. The actual location of the application server is determined by the access point, therefore, a single client application with the same header in the wireless device can reach different application server determined by the access point in the store. For example,
Header in store A: http:///lindex.html
Will be translated into http://www.company_{—}11.com/branch7/index.html and
Header in store B: http:///index.html
Will be translated into http://www.company_{—}33.com/branch66/index.html

Thus, utilizing the invention, the localized information is easily found by a user at the location where the user may submit or otherwise consume the coupon. This allows a business to increase customer loyalty by providing them Internet connectivity at a specific location in a manner that enables them to interact for an improved in-store experience and better service overall

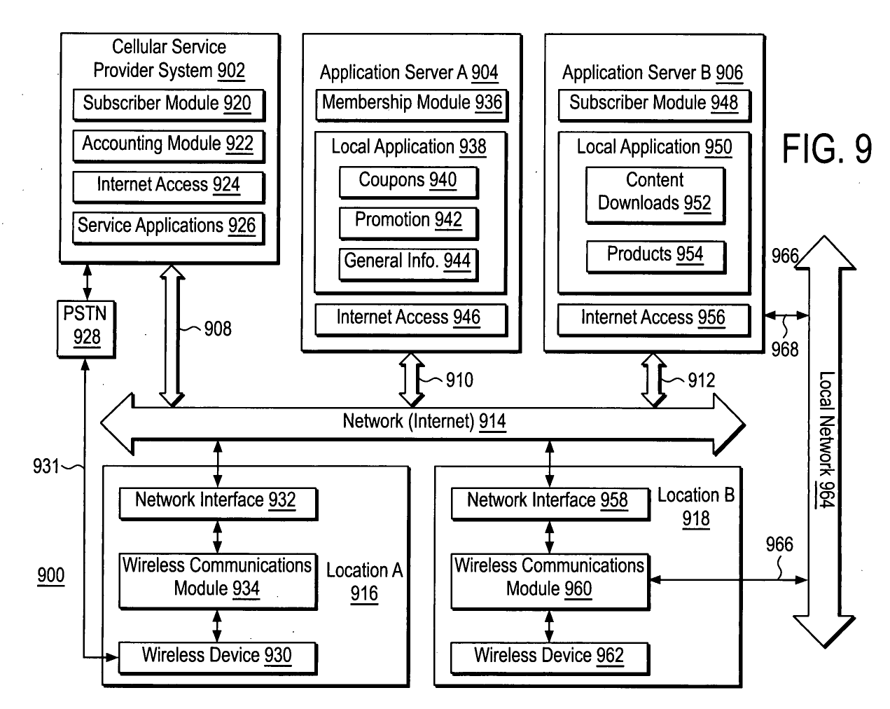

Referring to FIG. 9, an illustration of a system 900 configured according to the invention for providing communication with wireless devices at locations is shown. The system includes servers 902, 904, 906, configured to provide services to a wireless device. Each is configured to communicate via communication lines 908, 910, 912, to a network 914, such as a LAN, the Internet, or other network communication media. Local systems 916 (Location A), 918 (Location B), are configured to communicate with the servers via the network 914 to provide local customer service and other functions as may be appropriate for a local business application. The server 902 is a cellular service provider system that provides service to cellular telephones. The server includes a subscriber module 920 configured to manage subscriber information, including subscriber membership status and related information. An accounting module 922 is included to manage accounting information related to subscribers, such as any fees that are due or paid, any statistical information that may be relevant to membership status or promotional offers, and other accounting related information. An Internet access module 924 is also included to provide access to the Internet as may be appropriate in a particular application. Service application module 926 is included for providing particular services to users via the cellular system. A conventional system would provide services via the PSTN 928 as conventional services. Signals are typically transmitted between the wireless device 930 and the cellular service provider system via cellular media connections 931. As discussed above, conventional cellular services are limited in access and support. According to the invention, if such services were able to users, local access that is specialized and directed to users at specific locations could provide a valuable business service value.

Still referring to FIG. 9, the Location A 916 includes a network interface 932 that is configured to receive signals from wireless communication module (WCM) 934, which receives signals from wireless device 930. In operation, a user of the wireless device can arrive at Location A and communicate a signal to the wireless module to get local information. The signal is transmitted to the application server A 904, where local information is processed and sent to the wireless device for use by the user of wireless device 930.

Similarly, a user can arrive at Location B 918 to retrieve local information that is pertinent to Location B. Application server B includes a subscriber module 948 configured to maintain subscriptions, payment history and other subscriber information relevant to subscribers use of the system at Location B. The local application 950 is configured to service the local wireless device users at Location B. The local application 950 may include a content downloads module 952 configured to enable downloadable content, and products module 954 may be configured to enable downloadable products, such as programs and related data. Internet access module 956 is configured to enable communication with the Internet and connected devices via communication link 912. A network interface 958 connects Wireless Communication Module (WCM) 960 to the network 914, which connects the wireless device 962 to all associated servers and devices. The wireless device may contact WCM 960 to obtain local information, or even products that may be downloaded at that location. The WCM may communicate via the network interface 958 or with local network 964 via communication link 966 to LAN 964. The LAN may then connect to the Application server B 906 via communication link 968. Any of these communication links may be configured with convention media communication links. Server 904 and 905 may reside in the same computer.

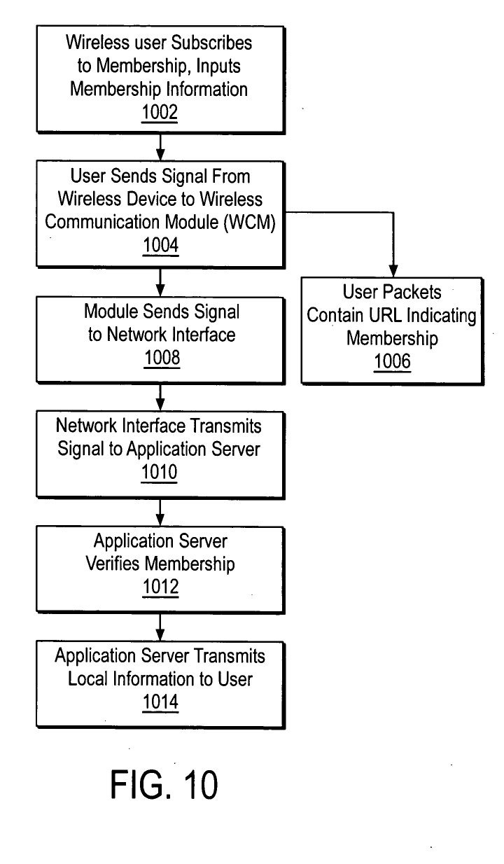

Referring to FIG. 10, a sample method of operation for the inventive method are illustrated. This method illustrates embodiments of the invention and are intended as sample embodiments, not as limitations to the invention or as exclusive examples. Those skilled in the art will understand and agree that other embodiments are possible, given the scope of the invention, which is defined by the appended claims and al equivalents.

Referring to FIG. 10, a process 1000 is illustrated for transmitting local and proximal information to a user of a wireless device. In an optional first step, 1002, a wireless user subscribes to membership, whether there is a charge or cost for a membership or not, and inputs membership information. This information may be quite simple, such as a name and email address, or it may be more detailed, depending on the application. After the user is registered, the user can access a merchant's system by using a wireless device at the merchant's location. In step 1004, the user sends a signal from a wireless device to wireless communication module at a merchant's location. The signal may be in the form of a packet that contains a URL in step 1006 that indicates membership to the merchant's system. In practice, the URL may relate to multiple merchants that subscribe to the system, or may have certain blocks of merchants in different industries and product or service businesses that offer wireless local information to customers. In response to the packet being sent, the module sends the signal to a network interface in step 1008. The network interface then transmits a signal to an application server in step 1010, where the signal send from the user's wireless device is processed. In an optional step, the application server then verifies the membership in step 1012, and the process is almost complete. The application server transmits local and proximal information to the user in step 1014.

The invention is directed to a method and apparatus for efficiently exchanging local information according to commands via a URL between a wireless device, such as a cellular telephone or PDA, and a data interface configured to receive such data. The interface may be a conventional data processing device such as a computer server. In one embodiment, a communication interface is configured to exchange digital data configured with a first header format such as OBEX. The communication interface is also configured to exchange digital data configured with a second header format with a device such as computer. Although this embodiment is described and illustrated in the context of the use and operation of a wireless device, the scope of the invention extends to other applications where convenient and efficient data transmission is desired. Furthermore, while the foregoing description has been with reference to particular embodiments of the invention, it will be appreciated that these are only illustrative of the invention and the changes may be made to those embodiments without departing from the principles of invention, the scope of which is defined by the appended claims.

1. For use in a communication interface for communication between a wireless device and the communication interface to gather local and proximal information, the communication interface being configured to communicate with other devices communicating with a network and configured to facilitate data communication between the wireless device and other devices connected to the network to retrieve and otherwise consume information pertinent to a particular location, a computer readable medium having stored thereon a plurality of sequences of instructions, said sequences of instructions including instructions that, when executed by a processor, cause said processor to perform the steps of:
receiving a packet having an embedded information address and command from a wireless device that is enabled with a protocol to establish a communication link with an application server;
establishing communication link with the application server;
retrieving localized information from the application server according to the received embedded command;
forwarding the location related data to the wireless device.

2. A processor according to claim 1, wherein the processor further performs the steps of:
receiving a packet having an embedded information address and command from a wireless device to establish a communication link with an application server;
establishing communication link with the application server.

3. A processor according to claim 1, wherein the information address is a URL that determines the destination of an application server accepted by the processor.

4. A processor according to claim 1, wherein the information address is a URL that provides a different destination of an application server that will be forced to the default destination by the processor.

5. A processor according to claim 1, wherein the information address is a data stream having unique information that can be interpreted by the processor as a URL.

6. A processor according to claim 1, wherein the information address is a data stream having unique information that can be interpreted by the processor as a URL that provides a different destination of an application server that will be forced to the default destination by the processor.

7. A processor according to claim 1 which the protocol is an OBEX protocol.

8. For use in a communication interface for communication between a wireless device and the communication interface, the communication interface being configured to communicate with other devices via the Internet and being further configured to facilitate data communication between the wireless device and other devices, a computer readable medium having stored thereon a plurality of sequences of instructions, said sequences of instructions including instructions that, when executed by a processor, cause said processor to perform the steps of:
receiving data from a data packet having a network address stored in the packet header configured under a first format with the communication interface;
extracting the network address from the data packet with the communication interface; and
contacting a device located at the network address to obtain localized information.

9. A computer readable medium according to claim 8, wherein the step of receiving the data packet further includes receiving a data packet having a header containing data information pertaining to the intended destination of communication with the wireless device.

10 A computer readable medium according to claim 8 wherein the communication interface is configured to receive infrared signals from a cellular phone configured to transmit data packets, and wherein the step of receiving the data packet further includes receiving a data packet having a network address location to which the wireless device is configured to communicate to obtain localized information.

11. A computer readable medium according to claim 8, further comprising communicating with an application server in a manner to obtain localized information relevant to the location where a wireless device user is located.

12. A computer readable medium according to claim 8, further comprising communicating with an application server in a manner to obtain content relevant to the location where a wireless device user is located.

13. A computer readable medium according to claim 8, further comprising communicating with an application server in a manner to obtain music content relevant to the location where a wireless device user is located.

14. A computer readable medium according to claim 8, further comprising communicating with an application server in a manner to obtain graphic content relevant to the location where a wireless device user is located.

15. A computer readable medium according to claim 8, further comprising retrieving a data packet by receiving a data packet having a header configured under the Bluetooth protocol.

16. A computer readable medium according to claim 15, further comprising communicating with an application server in a manner to obtain localized information relevant to the location where a wireless device user is located.

17. A computer readable medium according to claim 15, further comprising communicating with an application server in a manner to obtain graphic content relevant to the location where a wireless device user is located.

18. A computer readable medium according to claim 15, further comprising communicating with an application server in a manner to obtain music content relevant to the location where a wireless device user is located.

19. A computer readable medium according to claim 5, wherein the step of receiving the data packet further includes receiving a data packet having a header containing data information including the location from where data may be downloaded from to the wireless device, the method further comprising:
storing the received data packet in a storage location;
transmitting a request for content to an application server; and
loading a stored response to the wireless device.

20. A system for use in a communication interface for communication between a wireless device and the communication interface to gather local and proximal information, the communication interface being configured to communicate with other devices communicating with a network and configured to facilitate data communication between the wireless device and other devices connected to the network to retrieve and otherwise consume information pertinent to a particular location by receiving a packet having an embedded information address and command from a wireless device that is enabled with a protocol to establish a communication link with an application server, establishing a communication link with the application server, retrieving localized information from the application server according to the received embedded command and forwarding the location related data to the wireless device.
